(19) United States
(12) Patent Application Publication
(10) Pub. No.: US 2005/0235173 A1
(43) Pub. Date: Oct. 20, 2005

(54) Reconfigurable integrated circuit

(75) Inventor: Bernardo De Oliveira Kastrup Pereira, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V.

(21) Appl. No.: 10/516,626

(22) PCT Filed: May 21, 2003
(86) PCT No.: PCT/IB03/02198

§ 371 Date: Nov. 30, 2004

(30) Foreign Application Priority Data
Jun. 3, 2002 (EP) 02077168.9

(51) Int. Cl. G06F 1/26; G06F 1/28; G06F 1/30

(52) U.S. Cl. 713/324

(57) ABSTRACT

The present invention describes an integrated circuit (100) having a processor that consists of a plurality of identical, or at least very similar, processing elements (120) organized in a regular grid. Each processing element (120) is capable of executing the desired functionality of the processor. The processing elements (120) are interconnected by a configurable interconnection network (140) and are controlled by a program sequencing issuing device (160) capable of handling exceptions in the instruction flow through the processing elements (120). Consequently, the integrated circuit (100) can be easily redesigned, thus reducing design effort and time-to-market for such architectures.

The invention relates to an integrated circuit having a plurality of processing elements for executing substantially in parallel at least a subset of a plurality of instructions; issuing means for configuring the plurality of processing elements by issuing a program-counter-driven instruction flow to the plurality of processing elements; and configurable interconnection means for connecting each processing element from the plurality of processing elements to at least a subset of other processing elements from the plurality of processing elements.

The ongoing downscaling of semiconductor dimensions has led and still leads to an increase of the number of building blocks being integrated on the available area of a semiconductor device, e.g. integrated circuit. Consequently, such devices become more versatile and the performance demands for such devices increase accordingly. This is particularly the case for circuits that are being designed to perform a dedicated task, e.g. real time digital audio of video signal processing, and which include so-called application-specific instruction set processors (ASIPs), which may have architectures as defined in the opening paragraph.

The ever increasing performance demands for ASIPs combined with the technology downscaling typically imply that for a next generation ASIP not only more processing elements are integrated into the design, but also that the IC architecture is redesigned from scratch, because the performance of the previous generation processing elements is no longer sufficient to meet the requirements for the new ASIP.

However, this trend is associated with a problem that becomes an increasingly difficult hurdle to overcome for forthcoming integrated circuit technologies. The increase of processing elements in those integrated circuits and the aforementioned limited reusability of these processing elements in future generation ICs implies an ongoing increase in design effort for the designers of these ICs. In addition, the increasing number of processing elements to be included in the IC design introduce design complications, because the necessary interconnect between those processing elements becomes increasingly complex. This already is starting to lead to difficult routing issues; interconnect lines between two processing elements can become so long that the transmission delay on the line jeopardizes or even prevents the performance requirements from being met. This is a very serious problem, because the required time-to-market for ICs is becoming shorter and shorter, which obviously clashes with the aforementioned increasing design complications.

It is an object of the present invention to provide an integrated circuit of kind described in the opening paragraph that can be upgraded with a relatively small design effort.

The invention is defined by the independent claims. Advantageous embodiments are defined in the dependent claims.

According to the present invention, the required resources for the processing architecture are combined in each processing element and distributed over the available silicon real estate in a regular grid, e.g. a two-dimensional repetitive layout. Although it obviously creates some area overhead because, in contrast to prior art ASICs, all or at least most processing elements will comprise building blocks that might not be used during certain clock cycles, it is emphasized that this is not considered to be a drawback, since the ongoing semiconductor dimension downscaling allows for more and more functionality to be integrated onto an integrated circuit. More importantly, the combination of predominantly homogeneous processing elements and the regular grid allows for fast and cheap redesign of processing architectures. In contrast to prior art integrated circuits, where two architectures for two application domains typically both had to be redesigned from scratch, the integrated circuit of the present invention can simply reuse the one design by redefining the interconnect structure between the processing elements, or by redesigning only a single processor element, thus greatly reducing the time-to-market of the second IC. Furthermore, the second IC will also be less costly to produce, because the lithographic mask set of the first IC can be completely reused apart from the mask defining the interconnect, e.g. the VIA mask. Furthermore, when the number resources integrated in the first design are no longer sufficient to meet the performance requirements of the IC, the IC can simply be extended by adding an additional row or column of processing elements to the grid, which involves a minor design effort only.

It is particularly advantageous if the integrated circuit comprises very long instruction word (VLIW) processor architecture and the subset of the plurality of instructions comprises a very long instruction word. More and more processing elements are being integrated in VLIW processors, which leads to serious routing issues between the various processing elements. By realizing a VLIW processor according to the teachings of the present invention, a processor architecture is obtained where these routing problems are avoided because every processing element is always close to a required resource.

It is a further advantage if the configurable interconnection means connect each processing element to each nearest neighboring processing element in the grid. Consequently, this yields a regular grid with complete connectivity. This provides increased flexibility in the use of the integrated circuit. For instance, the grid of processing elements can be used as a data flow machine, where each processing element is configured by the issuing means and kept in that configuration for several clock cycles, with the data being rippled from one side of the grid to another side of the grid. This is particularly advantageous for loop executions, because the dimensions of the grid can be tuned to the dimensions of the loop body, which can result in a whole loop or a large data-autonomous part of the loop being mapped on the grid. Consequently, the performance of the-loop execution will be dramatically enhanced, because the slow communication between the issuing means and/or the processing elements with data and instruction memories is greatly reduced. Obviously, such data flow applications can also be executed on a grid lacking full connectivity, albeit with reduced flexibility compared to the grid with complete connectivity, e.g. a grid in which each processing element is connected to all its nearest neighbors. On the other hand, the processing elements can also be operated in the traditional VLIW way exploiting instruction-level parallelism on a cycle-by-cycle basis. Thus, the IC can be seen as a reconfigurable device, because during operation the configuration of the IC can be switched from the dataflow mode to a traditional VLIW mode.

At this point, it is emphasized that there are important fundamental differences between known reconfigurable devices like field programmable gate arrays (FPGAs) and the regularly structured IC according to the present invention. Not only are the known reconfigurable devices typically very slow because of the large number of reconfiguration points that have to be accessed during configuration of the device, but the known reconfigurable devices are not capable of exception handling, like the switching of a configuration context, i.e. a very long instruction word, of the processor architecture following the execution of a jump instruction or a conditional expression like a branch instruction. Therefore, those skilled in the art of designing high-performance ICs will look away from the FPGA related domain, because those architectures do neither offer the necessary performance nor offer the required functionality.

It is another advantage if the configurable interconnection means comprise bypassing means for bypassing a processing element from the plurality of processing elements. The use of bypassing means, e.g. multiplexers or other switching elements, in or around the processing elements further improves the performance of the IC, because not-neighboring processing elements can be in direct connection with each other if the processing elements in between the two communicating processing elements are bypassed. In addition, more than one connection path can be available between two different processing elements, configurable routing means like multiplexers being available for choosing which connection path is to be used. Furthermore, longer-distance connection paths can be provided, connecting processing elements that are not nearest neighbors. Again, configurable routing means can be used for choosing the appropriate connection paths.

It is yet another advantage if a processing element from the plurality of processing elements comprises a data storage unit, a function unit and an internal intercommunication network coupling the function unit to the data storage unit. By providing each processing element with a function unit and a data storage element, e.g. a small memory or a distributed register file, the slow communications between function units and central memories and/or register files can be avoided or at least reduced and the IC performance is enhanced. This is even more the case if the data storage element is also coupled to the configurable interconnection means, because then it can also serve as data suppler for function units in other processing elements.

In an embodiment of the present invention, the processing element comprises at least a further unit; the function unit, the further unit and the data storage unit being organized as a very long instruction word (VLIW) processor data path. This embodies a hierarchical VLIW architecture, which enhances the flexibility of the design. The further unit can either be a function unit or a data storage unit.

Advantageously, the issuing means are distributed over the processing elements in this embodiment. For instance, each VLIW processing element is equipped with its own operation register holding the control words that configure the data and control paths, e.g. the functionality of the function units and the routing between function units and data storage elements, of the VLIW processing element. Thus, a delocalized issuing architecture is obtained, which is again advantageous in terms of performance.

According to a further aspect of the invention, an electronic device is provided as claimed in claim 8. Integration of an IC according to the present invention into an electronic device leads to an electronic device with increased functional flexibility as well as a lower cost price, which substantially improves the marketability of such devices.

According to yet a further aspect of the invention, a method for designing an integrated circuit is provided as claimed in claim 9. Application of this method, for instance by means of a computer aided design (CAD) tool, will lead to an integrated circuit design having all the advantageous features as claimed in claim 1.

It is an advantage if the step of connecting each processing element from the plurality of processing element to at least a subset of other processing elements from the plurality of processing element includes connecting each processing element to each nearest neighboring processing element in the grid. By connecting a processing element to all its nearest neighbors, an IC design with a grid having complete interconnect can be obtained, which yields an IC design having the advantageous characteristics of the IC as claimed in claim 3.

The invention is described in more detail and by way of non-limiting examples with reference to the accompanying drawings, wherein:

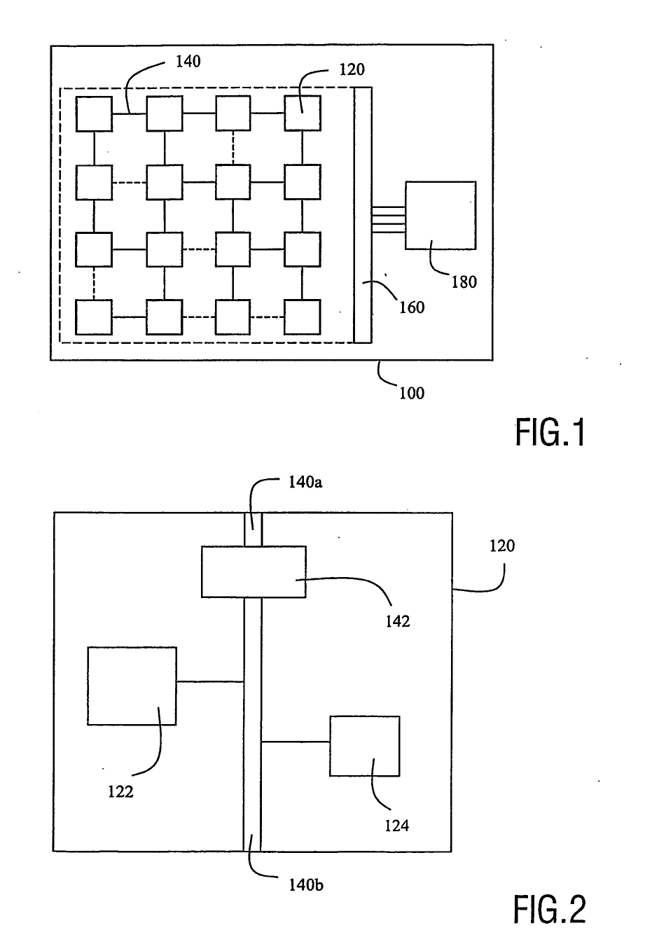

FIG. 1 depicts an integrated circuit according to the present invention;

FIG. 2 depicts an exemplary embodiment of a processing element according to the present invention;

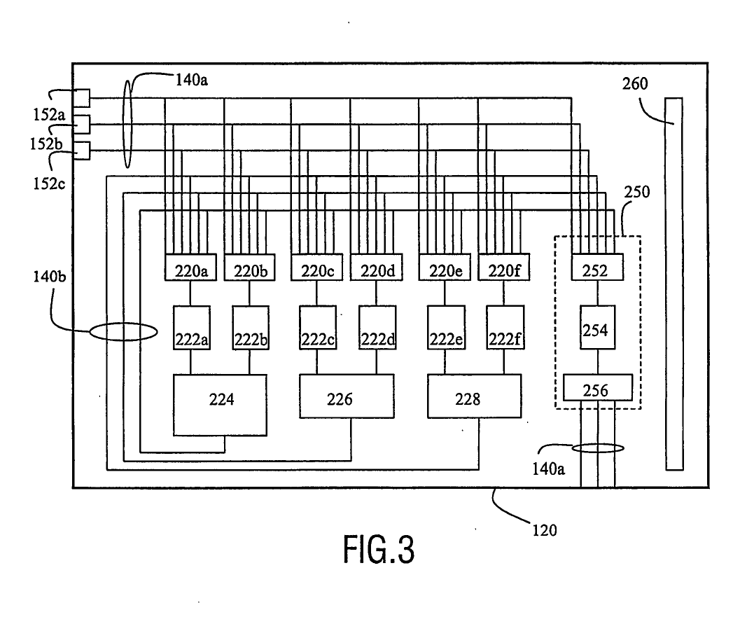

FIG. 3 depicts another exemplary embodiment of a processing element according to the present invention; and

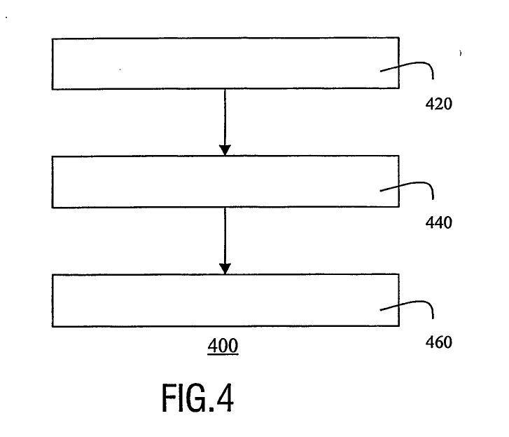

FIG. 4 depicts a flow chart of the method according to the present invention.

In FIG. 1, integrated circuit 100 has a processor comprising a plurality of processing elements 120 organized in a regular grid. The processing elements 120, which are all substantially similar to each other, e.g. have substantially the same functionality, are interconnected by reconfigurable interconnection network 140, e.g. an addressable data communication bus or a hardwired multiplexer network. Interconnection network 140 can be complete in the sense that every processing element 120 is connected to its nearest neighbor, or it can implement an incomplete network. In the latter case, some interconnects between processing elements 120 are absent, as indicated in FIG. 1 by the dashed lines. In addition, multiple connection paths may be provided between two processing elements, or longer-distance lines may be provided that connect processing elements that are not nearest neighbors. These alternatives have not been depicted in FIG. 1 for reasons of clarity only.

The processing elements 120 are coupled to an issuing device 160, as symbolized by the dashed box surrounding processing elements 120. Issuing device 160 is responsible for dispatching global communication, e.g. instructions, from a central memory 180 to the plurality of processing elements 120. Furthermore, the issuing device is responsible for handling exceptions and other configuration context switches, i.e. VLIW changes, in the grid of processing elements 120. In short, issuing device 160 is responsible for the program sequencing to and the control of processing elements 120.

For instance, the issuing device 160 will fetch instruction bundles, like VLIW instructions, from a central memory 180 on the basis of a value of its program counter, and will partition the bundles and dispatch the separate instructions to the appropriate processing elements 120. In a next step, the program counter of the issuing device will be routinely altered, e.g. incrementally increased or decreased, and a next instruction bundle will be fetched. However, if one of the processing elements 120 signals the detection of an exception, e.g. a jump instruction being taken or a branch condition being met, or if an interrupt is being signaled and so on, issuing device 160 will reset its program counter according to the exception and, if necessary, will flush the redundant data from processing elements 120 before issuing new instructions to the processing elements 120 on the basis of the reset value of the program counter. It will be recognized by those skilled in the art that this is a well-known way of controlling a processing architecture implementing instruction-level parallelism.

However, the combination of the mapping of the desired processor functionality of the integrated circuit 100 on every processing element 120 of the processor with the organization of the processing elements 120 in a regular grid with the at least partial interconnect between the processing elements 120 provides an important advantage over prior art instruction-level-parallelized processor architectures. In the integrated circuit 100 according to the present invention, the direct data communication between any processing element 120 and a neighboring processing element has the same latency throughout the whole grid. Thus, by definition, if a timing constraint is satisfied between any of the processing elements 120 and a connected neighboring processing element, this holds for all (connected) nearest neighbors of processing elements 120. Not only does this imply that the design of the processor architecture becomes more straightforward, but it also provides a data flow driven processing mode that is not typically associated with instruction level parallelized processing.

In a data flow mode, a set of instructions are mapped on the processing elements 120 of integrated circuit 100 and the interconnection network 140 is configured to connect a processing element 120 to its appropriate neighbors. Now, for a period of time, e.g. a number of clock cycles, this configuration is frozen and data is allowed to ripple through the grid in a classical data flow manner. This is particularly useful if the grid is large enough to map a complete loop body onto, which then means that loop execution can be realized in a highly effective and parallel manner. In addition, if the loop is too large to be mapped in its entirety onto the grid, the data flow concept can still be utilized by breaking up the loop into smaller loops, data dependencies permitting, that can be mapped onto the grid on their entirety. If, instead, the loop body is too small to keep a majority of the processing elements in the grid busy, software pipelining can be applied, which can be particularly effective if the processing elements 120 have a data storage unit like a part of a distributed register file or a random access memory, because intermediate results can be stored in the local storage unit and can be forwarded to a neighboring processing element when necessary. This enables high speed, distributed communication, which typically means that very few communication conflicts occur in the processor architecture of integrated circuit 100, if any. The time period that the grid is kept in data flow mode can be monitored by a simple clock cycle counter, which is coupled to and can be integrated in the issuing device 160, although other control schemes are feasible as well, like data or control output monitoring in a synchronous or asynchronous data flow mode. To increase flexibility even further, intercommunication network 140 can include hardware to bypass individual processing elements 120 in the grid, for instance by means of multiplexers that provide a direct routing through or around a processing element 120 or by means of hard-wired bypasses.

Now, the following Figs. will be described with backreference to FIG. 1 and its detailed description. Corresponding reference numerals will have the same meaning, unless explicitly stated otherwise. In FIG. 2, an exemplary embodiment of a processing element 120 is depicted. Processing element 120 has a data storage unit 122, e.g. a memory or a part of a distributed register file, and a function unit 124, which can be an arithmetic logic unit (ALU), an address computation unit (ACU), a multiplier, a multiply-accumulate unit (MAC) and so on. The data storage unit 122 is coupled to function unit 124 through an internal intercommunication network 140b, which is either directly coupled to an external intercommunication network 140a or coupled to external intercommunication network 140a through a control unit 142. The control unit 142 can for instance be a distributed bus controller or a network of multiplexers responsive to issuing device 160. Both internal communication network 140b and external communication network 140a, which together form intercommunication network 140, can be realized as a point-to-point hard-wired network, as a data communication bus, or as a combination thereof.

In FIG. 3, which is described in backreference to FIG. 2 and its detailed description, another exemplary embodiment of a processing element 120 is given. Multiplexers 220a-b, 220c-d and 220e-f are respectively coupled to a function unit 224, a further unit 226 and a data storage unit 228 through buffers, e.g. register files, 222a-f. The further unit 226 may be a further function unit or a further data storage unit. This is by way of non-limiting example only, other configurations, for instance a configuration in which several units share a buffer, can be thought of without departing from the scope of the invention. In the embodiment of FIG. 3, function unit 224 can be a 2-input ALU with its data inputs coupled to buffers 222a and 222b, respectively. Further unit 226 can be a 2-input MAC with its data inputs coupled to buffers 222c and 222d, respectively and data storage unit 228 can be a random access memory with an address input coupled to buffer 222e and a data input coupled to buffer 222f, although many other configurations are of course possible.

The inputs of multiplexers 220a-f are coupled to an external interconnection network 140a and an internal interconnection network 140b. External interconnection network 140a is coupled to processing element 120 through data input ports 152a-c on the data input side and through output arrangement 260 on the output side. The number of data input ports is defined by the number of neighbors the processing element 120 is connected to. Output arrangement 250 has a multiplexer 252, an optional buffer 254 and an output port 256 for coupling processing element 120 to its neighboring processing elements. This ensures that only relevant data is broadcasted to connected neighboring processing elements through output port 256. It is pointed out that output arrangement 250 can also serve as a bypass for the processing element 120; the data input received through input ports 152a-c can be directly forwarded to other processing elements through the appropriate configuration of multiplexer 252. In FIG. 3, internal interconnection network 140b is fully connected, e.g. each output of units 224, 226 and 228 is coupled to multiplexers 220a-f and multiplexer 252. It is emphasized that this is by way of non-limiting example only, partially connected interconnection network 140b can alternatively be used without departing from the scope of the present invention.

Issuing device 160 can be distributed over processing elements 120. In FIG. 3, a local issuing device 260 is responsible for the control of the data path of processing element 120, by controlling the configuration of multiplexers 220a-f, issuing opcodes to the function units, addresses to the data storage units, and, optionally, controlling the configuration of multiplexer 252. Local issuing device 260 could have its own local operation register, so the global VLIW instruction can simply be formed by linking all local operation registers. Optionally, the processor instruction memory itself could be partitioned into multiple memory blocks, each memory block being local to a processing element 120, each memory block containing the part of the very long instruction word relevant to its corresponding processing element. In a further embodiment, each local issuing device 260, having its own local instruction memory block and local operation register, could be associated with its own local program sequencing and control logic, and its own Program Counter (PC), which means that each processing element 120 could operate as a VLIW processor itself.

At this point, it is emphasized that the vast flexibility of the integrated circuit 100 according to the present invention enables the integration of very large scale parallelism in its architecture, which renders integrated circuit 100 suitable for the performance of very demanding computations, e.g. broadband digital signal processing, that are difficult, if not currently impossible, to achieve with known architectures. Therefore, integration of an integrated circuit 100 according to the present invention into an electronic device requiring such demanding computations, e.g. future generation mobile telecommunication devices, will not only make the realization of such future technologies feasible, but will also make the technology affordable, because of the limited design cost of the integrated circuit 100.

In FIG. 4, a flow chart 400 depicts the crucial steps for designing an integrated circuit with a processing architecture according to the present invention.

In a first step 420, the processing elements from the plurality of processing elements are designed to be substantially similar to each other and each processing element from the plurality of processing elements is designed to be capable of executing each instruction from the plurality of instructions. Obviously, this has only to be done for a single of the processing elements 120, since all other processing elements in the grid should be largely similar to this single processing element 120. This approach drastically reduces the design effort for such very large scale integration circuits utilizing instruction-level parallelism.

In a second step 440, the plurality of processing elements are layed out in a regular grid wherein a distance between a processing element from the plurality of processing elements and a nearest neighboring processing element from the plurality of processing elements in a first direction is substantially the same as a distance between the processing element and a nearest neighboring processing element from the plurality of processing elements in a second direction. The organization of the processing elements in the regular grid not only enables the aforementioned reconfigurable behavior of the integrated circuit 100, e.g. the ability to switch between a data flow mode and an instruction-level parallelism mode, but it also offers the possibility to reuse the logic layout for other applications when another interconnection structure is required.

This can be realized in a third step 460, where each processing element 120 from the plurality of function units is connected to at least a subset of other processing elements from the plurality of processing elements. Optionally, each processing element 120 can be connected to each nearest neighboring processing element in the grid to yield a completely connected two-dimensional grid in the sense that each processing element 120 is connected to each nearest neighbor. The definition of different interconnection networks 140 for a grid of processing elements 120 enables the reuse of the grid of processing elements 120 for other applications based on the same overall logic layout. In such a case, only the interconnect has to be redefined, which means that only a small design effort is required and only one or a few interconnect masks (e.g. a VIA mask, or an upper metal layer mask) have to be redeveloped. Both these advantages realize a substantial cost reduction in the development of follow-up IC designs.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An integrated circuit comprising:
a plurality of processing elements for executing substantially in parallel at least a subset of a plurality of instructions;
issuing means for configuring the plurality of processing elements by issuing a program-counter-driven instruction flow to the plurality of processing elements; and
configurable interconnection means for connecting each processing element from the plurality of processing elements to at least a subset of other processing elements from the plurality of processing elements;
characterized in that:
the processing elements from the plurality of processing elements are substantially similar to each other, each processing element from the plurality of processing elements being capable of executing each instruction from the plurality of instructions; and
the plurality of processing elements are laid out in a regular grid wherein a distance between a processing element and a neighboring processing element from the plurality of processing elements in a first direction is substantially the same as a distance between the processing element and a neighboring processing element from the plurality of processing elements in a second direction that is different from the first direction.

2. An integrated circuit as claimed in claim 1, wherein the integrated circuit comprises a very long instruction word processor architecture and the subset of the plurality of instructions comprises a very long instruction word.

3. An integrated circuit as claimed in claim 1, characterized in that the configurable interconnection means connect each processing element to each nearest neighboring processing element in the grid.

4. An integrated circuit as claimed in claim 1, characterized in that the configurable interconnection means comprise bypassing means for bypassing a processing element from the plurality of processing elements.

5. An integrated circuit as claimed in claim 1, characterized in that a processing element from the plurality of processing elements comprises a data storage unit, a function unit and an internal intercommunication network coupling the function unit to the data storage unit.

6. An integrated circuit as claimed in claim 5, characterized in that the processing element comprises at least a further unit; the function unit, the further unit and the data storage unit being organized as a very long instruction word processor data path.

7. An integrated circuit as claimed in claim 6, characterized in that the issuing means are distributed over the processing elements.

8. A data processing device having an input for receiving a digital data stream and having an output for transmitting a humanly perceptible data result resulting from the digital data stream, chararacterized in that the input is coupled to the output via an integrated circuit as claimed in claim 1, the integrated circuit being arranged for extracting the data result from the digital data stream.

9. A method for designing an integrated circuit, the integrated circuit comprising:
a plurality of processing elements for executing substantially in parallel at least a subset of a plurality of instructions;
issuing means for configuring the plurality of processing elements by issuing a program-counter-driven instruction flow to the plurality of processing elements; and
configurable interconnection means for connecting each processing element from the plurality of processing elements to at least a subset of other processing elements from the plurality of processing elements;
characterized by the method comprising the steps of:
designing the processing elements from the plurality of processing elements to be substantially similar to each other, and each processing element from the plurality of processing elements to be capable of executing each instruction from the plurality of instructions;
laying out the plurality of processing elements in a regular grid wherein a distance between a processing element and a neighboring processing element from the plurality of processing elements in a first direction is substantially the same as a distance between the processing element and a neighboring processing element from the plurality of processing elements in a second direction; and
connecting each processing element from the plurality of processing elements to at least a subset of other processing elements from the plurality of processing elements.

10. A method as claimed in claim 9, characterized in that the step of connecting each processing element from the plurality of processing elements to at least a subset of other processing elements from the plurality of processing elements includes connecting each processing element to each nearest neighboring processing element in the grid.
